(19) United States
(12) Patent Application Publication
(10) Pub. No.: US 2026/0066207 A1
(43) Pub. Date: Mar. 5, 2026

(54) PYRO FUSE WITH QUICK INTERRUPTION OF ELECTRICALLY FAULTED CIRCUIT

(71) Applicant: Littelfuse, Inc., Chicago, IL (US)

(72) Inventor: Michael Fasano, Watertown, CT (US)

(73) Assignee: Littelfuse, Inc., Chicago, IL (US)

(21) Appl. No.: 18/825,115

(22) Filed: Sep. 5, 2024

(51) Int. Cl. H01H 85/02; H01H 39/00; H01H 85/18

(52) U.S. Cl. CPC H01H 85/0241; H01H 39/006; H01H 85/18; H01H 2085/0266

(57) ABSTRACT

A circuit protection device may include a current sensor and a pyrotechnic fuse connected to the current sensor, wherein the pyrotechnic fuse includes a housing and a busbar extending through the housing, and wherein the busbar is positioned between a first chamber and a second chamber. The circuit protection device may further include a piston within the first chamber, wherein the piston is operable to receive a force from a squib, and wherein in response to a signal from the current sensor, the force from the squib causes the piston to create an opening in the busbar.

### FIELD OF THE DISCLOSURE

Embodiments of the present disclosure relate generally to circuit protection devices and, more particularly, to a pyro fuse with quick interruption of an electrically faulted circuit.

### BACKGROUND

Due to the increasing electrification of motor vehicles, both higher battery currents and higher voltage levels are reached, especially in the field of drive technology, which leads to increasing demands on respective fuse elements with regard to maximum isolation currents, dielectric strength, and error probability. In the event of a fault, for example after a crash, reliable disconnection or separation of the battery from the rest of the wiring harness in the vehicle must be ensured. Due to the high voltages, there are considerable risks for passengers and rescue personnel, which must be reliably avoided. To reduce the probability of errors and increase the safety of a vehicle's electrical system, both active and passive components are used as safety elements.

Active fuse elements are disconnectors that cut a line driven by a drive. The drive may be controlled by pyrotechnics, for example. In particular, a disconnection signal can result in activation of the drive, whereupon the active disconnection element is disconnected. However, active disconnecting elements are susceptible to electric arcs due to their very fast mechanical separation of the load path. If an arc burns across the separation point, a high current can still flow and a safe separation of the on-board power supply from the battery is not guaranteed.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

In one approach, a circuit protection device may include a current sensor and a pyrotechnic fuse connected to the current sensor, wherein the pyrotechnic fuse includes a housing and a busbar extending through the housing, and wherein the busbar is positioned between a first chamber and a second chamber. The circuit protection device may further include a piston within the first chamber, wherein the piston is operable to receive a force from a squib, and wherein in response to a signal from the current sensor, the force from the squib causes the piston to create an opening in the busbar.

In another approach, a pyrotechnic fuse may include a housing, and a busbar extending through the housing, wherein the busbar is positioned between a first chamber defined by a first section of the housing and a second chamber defined by a second section of the housing. The pyrotechnic fuse may further include a piston within the first chamber, wherein the piston is operable to receive a force from a squib coupled to the first section of the housing, and wherein in response to a signal from a current sensor, the force from the squib causes the piston to create an opening in the busbar.

In yet another approach, a method may include connecting a pyrotechnic fuse to a current sensor, the pyrotechnic fuse comprising a busbar extending through a housing, wherein the busbar is positioned between a first chamber and a second chamber. The method may further include receiving a signal from the current sensor that an overcurrent event has occurred, and in response to the signal from the current sensor, generating a force from a squib coupled to the housing, wherein the force biases the piston towards the busbar to create a break in the busbar.

### BRIEF DESCRIPTION OF THE DRAWINGS

The accompanying drawings illustrate exemplary approaches of the disclosed embodiments so far devised for the practical application of the principles thereof, and in which:

FIG. 1 is a cross-sectional view of a pyrotechnic fuse, in accordance with exemplary embodiments of the disclosure;

FIG. 2 is a side view of a busbar of the pyrotechnic fuse, in accordance with exemplary embodiments of the disclosure;

FIG. 3 is a cross-sectional view of another pyrotechnic fuse, in accordance with exemplary embodiments of the disclosure; and

FIG. 4 is a flowchart of a method for operating a pyrotechnic fuse, in accordance with exemplary embodiments of the disclosure.

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

### DETAILED DESCRIPTION

The present disclosure will now proceed with reference to the accompanying drawings, in which various approaches are shown. Embodiments of the present disclosure relate to novel pyro fuses with quick interruption of electrically faulted circuits. More specifically, a pyro fuse may include a piston within a housing, and a squib operable with the piston and one or more sensor systems. The squib forms a pyrotechnic device that is capable of propelling the piston within the housing, towards a busbar. The busbar extends through the housing and separates the housing into an upper section and a lower section. When an igniter of the squib is activated by an electronic signal sent from a sensor, such as a current sensor, the squib fires a propellant and forces the piston against the busbar, fracturing it to release an arc suppressant material (e.g., sand) into the lower section of the housing, In some embodiments, the busbar may have a pair of fracture locations, which are reduced thickness sections of the busbar capable of carrying the current, while also providing a means of fracturing the busbar parts thereby disrupting the current flow. Under normal operating conditions, the busbar is a continuous element. However, during a vehicle crash, for example, the igniter of the squib receives a specific signal and is activated, resulting in one or more breaks being formed in the busbar. Advantageously, embodiments herein provide the ability to switch off high currents and/or voltages, e.g., up to 16 kA and up to 1000 V, in a small space, and in a very short time <2 msec.

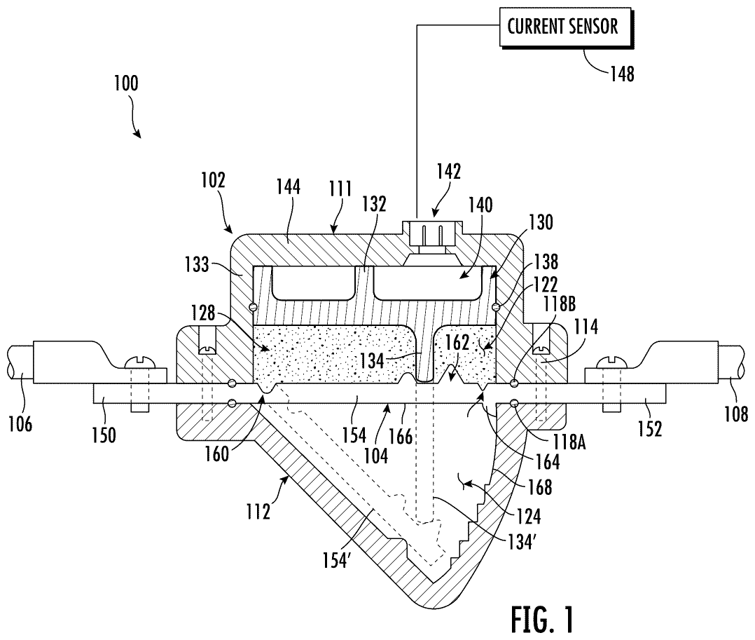

FIG. 1 is a side, cross-sectional view of a protection device 100 (hereinafter “device”) according to one or more embodiments. As shown, the device 100 may include a housing 102 and a busbar 104 connected between a first terminal 106 and a second terminal 108. The housing 102 may include a first section 111 coupled to a second section 112 using one or more fasteners 114 (e.g., screws, bolts, etc.). Positioned between the first and second sections 111, 112 of the housing 102 may be the busbar 104. The first section 111 and the busbar 104 may define a first chamber 122 of the device 100, while the second section 112 and the busbar 104 may define a second chamber 124 of the device 100. Within the first chamber 122 may be an arc suppressant filler 128. One or more sealing elements 118A, 118B (e.g., O-rings) may be positioned at an interface of the busbar 104 and the second section 112, and at the interface of the busbar 104 and the first section 111, respectively. In an initial configuration of the device 100, the arc suppressant filler 128 is located within the first chamber 122 but not the second chamber 124.

The device 100 may further include a piston 130 within the housing 102. More specifically, the piston may be located within the first chamber 122 of the first section 111 of the housing 102. In some embodiments, the piston 130 may include a head 132 extending between opposite sidewalls 133 of the first section 111, and a rod/shaft 134 extending from the head 132, towards the busbar 104. One or more sealing elements 138 (e.g., O-ring) may be located at an interface of an outer surface of the head 132 and an inner surface of the sidewalls 133. The piston 130 may include one or more piston chambers 140 beneath a squib 142, which is embedded in, and/or coupled to, an upper wall 144 of the housing 102.

Although non-limiting, piston 130 is made of non-conductive material, typically plastic or ceramic.

In some embodiments, the squib 142 may be a propellant charged squib capable of propelling the piston 130 towards the busbar 104. When an igniter of the squib 142 is activated by an electronic signal sent from a current sensor 148, the squib 142 fires the propellant, which generates a pressure within the piston chambers 140 and forces the piston 130 away from the upper wall 144 of the housing 102 and toward the busbar 104. The ignitor may receive a certain current of, for example, 1.75 A for a certain time, such as 500 msec. Embodiments herein are not limited in this context, however.

In some embodiments, the current sensor 148 is wired in series with the device 100, and may be wired via a communication cable into an electronic control unit (ECU) of a vehicle. The ECU is responsible for processing safety sensor information and, in the event of a crash, process information from a crash detector to then command a plurality of safety features to activate, e.g., airbags, pyro fuse, and more. The current sensor 148 is further operable to trigger the squib 142 if there is an overcurrent fault as well.

During fracturing of the busbar 104 and disruption of the current, arcs can occur. These arcs create discharges and gas discharges inside the housing 102. The arc suppressant filler 128 is designed to address such arcs. Although non-limiting, the arc suppressant filler 128 may be a flowable medium, such as sand, which acts as a heat sink and high dielectric medium as its phase changes from solid to liquid, e.g., when exposed to the heat generated by the arc. Thus, by rapidly absorbing heat from the arc, the sand cools the arc and eventually extinguishes it. Other arc suppressant filler materials may include calcium carbonate, talc (steatite), and others. In some embodiments, the arc suppressant filler 128 may include a promoter, such as melamine, guanidine, guanine, hydantoin, urea, melamine-formaldehyde, melamine-cyanurate polymers, boric acid, aluminum trihydrate, and derivatives thereof. Embodiments herein are not limited in this context, however.

As further shown, the busbar 104 may include a first end 150 opposite a second end 152, and a central section 154 located within the housing 102. Along the central section 154 is a first weakened section 158 and a second weakened section 160. As shown, the first weakened section 158 is located closer to the second end 152 of the busbar 104 and the second weakened section 160 is located closer to the first end 150 of the busbar 104. The busbar 104 may further include an engagement feature 162 adjacent the first weakened section 158. As shown, the shaft 134 of the piston 130 is in abutment with the engagement feature 162.

During use, movement of the piston 130 away from the squib 142 causes the shaft 134 of the piston 130 to fracture the central section 154 of the busbar, creating an opening at the first weakened section 158. In some embodiments, the busbar 104 may include a brace 164 extending from an underside 166 thereof, wherein the brace 164 is operable to engage an interior wall 168 of the housing 102 to focus the force from the piston 130 on the first weakened section 158. The brace 164 helps the central section 154 of the busbar 104 to resist bending and rotation until the opening is formed at the first weakened section 158.

When a sufficient force is applied to the busbar 104 by the piston 130, the central section 154 is fractured at the first weakened section 158 and then forced into the second chamber 124 by the shaft 134, as demonstrated by dashed lines 154′ and 134′, respectively. In some embodiments, no opening is created at the second weakened section 160. Instead, the central section 154 of the busbar 104 may be angularly displaced about the second weakened section 160 without fracturing it. With the central section 154 now dislocated, the arc suppressant filler 128 is pushed into the second chamber 124.

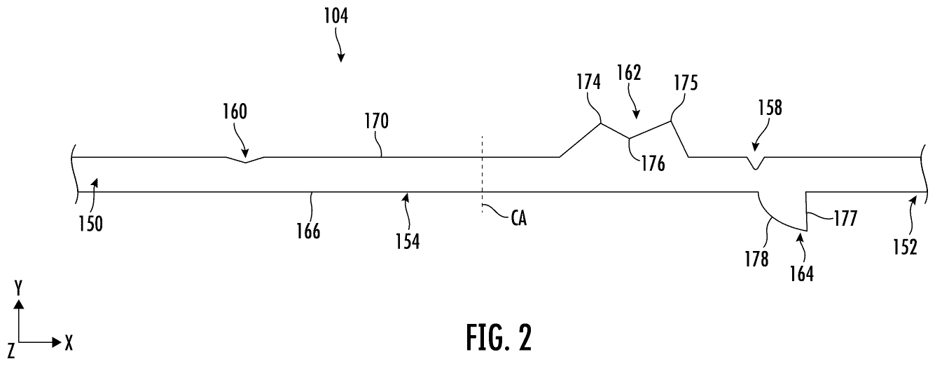

Turning now to FIG. 2, the busbar 104 will be described in greater detail. The busbar 104 may include the first end 150, the second end 152, and the central section 154 extending between the first and second ends 150, 152. A central axis ‘CA’ may generally divide the busbar 104 into two sections having substantially equal lengths (e.g., in the x-direction). The busbar 104 may further include an upper side 170 opposite the underside 166, wherein the upper side 170 partially defines the first chamber 122 of the housing 102, and the underside 166 partially defines the second chamber 124 of the housing 102.

The engagement feature 162 may extend vertically (e.g., along the y-direction) from the upper side 170, and is configured to retain the shaft 134 of the piston 130. In some embodiments, the engagement feature 162 may include a first peak 174, a second peak 175, and a depression 176 between the first and second peaks 174, 175. A free end of the shaft 134 of the piston 130 may abut a surface defining the depression 176, while the first and second peaks 174, 175 prevent lateral movement of shaft 134 in the x-direction. As further shown, the engagement feature 162 is offset from the central axis, closer to the second end 152 than to the first end 150. As a result, the force from the piston 130 will cause rotation of the central section 154 upon fracturing, as described above.

In some embodiments, the first weakened section 158 and the second weakened section 160 may have the same or similar geometries. However, in the embodiment shown, the first weakened section 158 may be thinner (e.g., in the y-direction) than the second weakened section 160. As a result, fracturing of the busbar 104 is more likely to occur at the first weakened section 158 rather than the second weakened section 160. The first weakened section 158 may be located between the engagement feature 162 and the brace 164. As shown, the brace 164 may include a support wall 177 for engagement with the interior wall 168 of the housing 102, and a curved or sloped surface 178 to ensure the severed end of the central section 154 can freely rotate past the brace 164 when the central section 154 begins to move downwards.

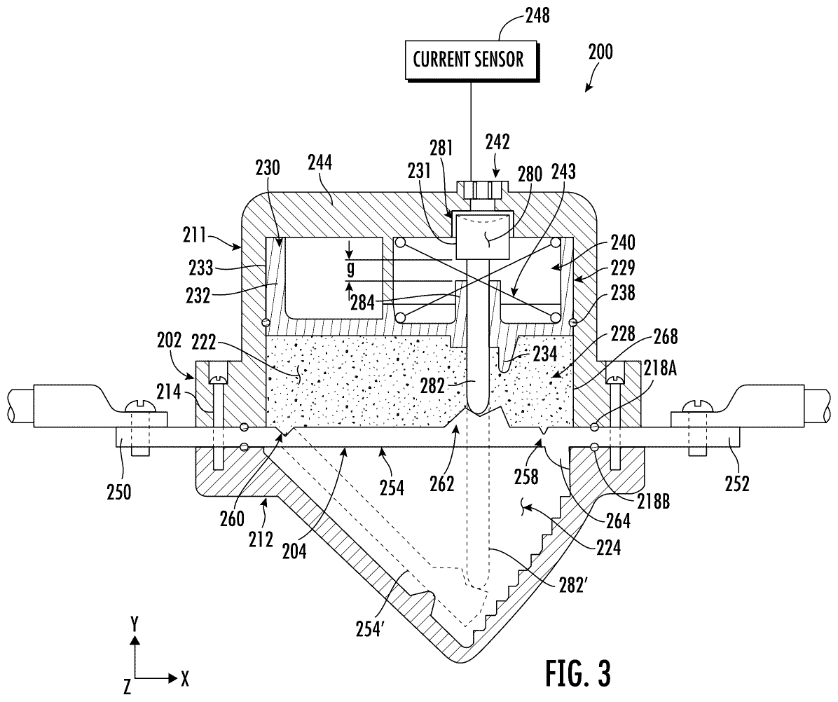

FIG. 3 is a side, cross-sectional view of another protection device 200 (hereinafter “device”) according to one or more embodiments. The device 200 may be the same or similar in many aspects to the device 100 described above. As such, only certain aspects of the device 200 will hereinafter be described for the sake of brevity. As shown, the device 200 may include a housing 202 and a busbar 204 connected between first and second terminals. The housing 202 may include a first section 211 coupled to a second section 212 using one or more fasteners 214 (e.g., screws, bolts, etc.). Sandwiched between the first and second sections 211, 212 of the housing 202 is the busbar 204. The first section 211 and the busbar 204 may define a first chamber 222 of the housing 202, while the second section 212 and the busbar 204 may define a second chamber 224 of the housing 202. Within the first chamber 222 may be an arc suppressant filler 228. One or more sealing elements 218A, 218B (e.g., O-rings) may be positioned at an interface of the busbar 204 and the first section 211, and at the interface of the busbar 204 and the second section 212, respectively. In an initial configuration of the device 200, the arc suppressant filler 228 is located within the first chamber 222 but not within the second chamber 224.

The device 200 may further include a piston assembly 229 within the housing 202. More specifically, the piston assembly 229 may be located within the first chamber 222 of the first section 211 of the housing 202. In some embodiments, the piston assembly 229 may include a first piston 230 and a second piston 231, wherein the second piston 231 extends through the first piston 230. The first piston 230 may include a head 232 extending between opposite sidewalls 233 of the first section 211, and a shaft 234 extending from the head 232, towards the busbar 204. One or more sealing elements 238 (e.g., O-ring) may be located at an interface of an outer surface of the head 232 and an inner surface of the sidewalls 233. The first piston 230 may include one or more piston chambers 240 beneath a squib 242, which is embedded in, and/or coupled to, an upper wall 244 of the housing 202.

In some embodiments, a helical compression spring 243 may be located within the piston chamber 240. More specifically, a first end of the helical compression spring 243 may be connected to the head 232 of the first piston 230 and a second end of the helical compression spring 243 may be connected to an underside of the upper wall 244. The helical compression spring 243 is used to bolster the force of the squib 242 to accelerate the first piston 230.

The second piston 231 may include a head 280 located within a cavity 281 of the upper wall 244, and a shaft 282 extending from the head 280, towards the busbar 204.

The cavity 281 and the head 280 may be located directly beneath the squib 242. The shaft 282 of the second piston 231 may be in direct physical contact with an engagement feature 262 of the busbar 204. Meanwhile, the shaft 234 of the first piston 230 may extend partially towards the busbar 204.

As further shown, the busbar 204 may include a first end 250 opposite a second end 252, and a central section 254 located within the housing 202. Along the central section 254 is a first weakened section 258 and a second weakened section 260, wherein the engagement feature 262 is located adjacent the first weakened section 258. As shown, the first weakened section 258 is located closer to the second end 252 of the busbar 204 and the second weakened section 260 is located closer to the first end 250 of the busbar 204.

During use, the squib 242, in response to a signal from a current sensor 248, creates an explosion, which generates pressure within the cavity 281 and forces the head 280 of the second piston 231 away from the upper wall 244 of the housing 202. The head 280 of the second piston 231 is forced towards the busbar 204, over a gap distance ‘g’, until it engages an upper surface of an inner cylinder 284 of the head 232 of the of the first piston 230. In some embodiments, a tip of the shaft 234 of the first piston 230 may also contact the engagement feature 262 after the head 280 of the second piston 231 makes contact with the inner cylinder 284. Engagement by both the shaft 234 of the first piston 230 and the shaft 280 of the second piston 231 ensure a greater transfer of force to the busbar 204 following the squib explosion.

Movement of the second piston 231 through the first piston 230 causes the shaft 282 of the second piston 231 to fracture the central section 254 of the busbar, creating an opening at/through the first weakened section 258. Both the first piston 230 and the second piston 231 are then biased together towards the arc suppressant filler 228. In some embodiments, the busbar 204 may include a brace 264 operable to engage an interior wall 268 of the housing 202 to focus the pressure from the piston assembly 229 on the first weakened section 258.

When a sufficient force is applied to the busbar 204 by the piston assembly 229, the central section 254 is sheared at the first weakened section 258 and then angularly displaced into the second chamber 224 by the shaft 282, as demonstrated by dashed lines 254′ and 282′, respectively. In some embodiments, no opening is created at the second weakened section 260. Instead, the central section 154 of the busbar 104 may rotate about the second weakened section 260 without shearing it. With the central section 254 now dislocated, the arc suppressant filler 228 is pushed into the second chamber 224.

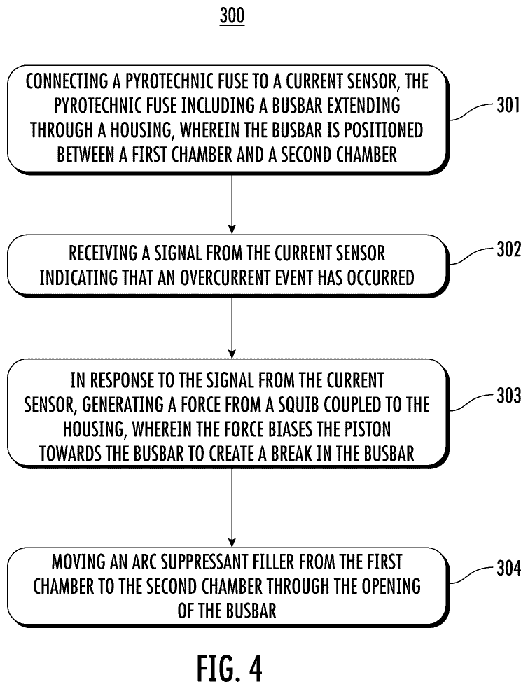

Turning now to FIG. 4, a flowchart of an example method 300 for operating the device 100 and/or device 200 is shown. At block 301, the method 300 may include connecting a pyrotechnic fuse to a current sensor, the pyrotechnic fuse including a busbar extending through a housing, wherein the busbar is positioned between a first chamber and a second chamber.

At block 302, the method 300 may include receiving a signal from the current sensor indicating that an overcurrent event has occurred.

At block 303, the method 300 may include, in response to the signal from the current sensor, generating a force from a squib coupled to the housing, wherein the force biases the piston towards the busbar to create a break in the busbar. In some embodiments, a shaft or rod of the piston is in direct physical contact with an engagement feature of the busbar. In some embodiments, a first weakened section is located adjacent the engagement feature, wherein the break in the busbar is created in the first weakened section. In some embodiments, the busbar is rotated or angularly displaced about a second weakened section of the busbar in response to the force on the busbar from the piston.

At block 304, the method 300 may further include moving an arc suppressant filler from the first chamber to the second chamber through the opening of the busbar.

The foregoing discussion has been presented for purposes of illustration and description and is not intended to limit the disclosure to the form or forms disclosed herein. For example, various features of the disclosure may be grouped together in one or more aspects, embodiments, or configurations for the purpose of streamlining the disclosure.

However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose. Those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A circuit protection device, comprising:
a current sensor;
a pyrotechnic fuse connected to the current sensor, the pyrotechnic fuse comprising:
a housing;
a busbar extending through the housing, wherein the busbar is positioned between a first chamber and a second chamber; and
a piston within the first chamber, wherein the piston is operable to receive a force from a squib, and wherein in response to a signal from the current sensor, the force from the squib causes the piston to create an opening in the busbar.

2. The circuit protection device of claim 1, further comprising an arc suppressant filler within the first chamber.

3. The circuit protection device of claim 2, wherein creation of the opening in the busbar causes the arc suppressant filler to move into the second chamber.

4. The circuit protection device of claim 2, wherein the arc suppressant filler is sand.

5. The circuit protection device of claim 1, further comprising a second piston within the first chamber, wherein the second piston comprises a head proximate the squib and a shaft extending through the piston, wherein the shaft is in abutment with the busbar.

6. The circuit protection device of claim 1, wherein the busbar comprises a first weakened section adjacent an engagement feature, wherein the piston comprises a shaft in abutment with the engagement feature.

7. The circuit protection device of claim 6, wherein the busbar further comprises a second weakened section, wherein the force from the squib causes the busbar to rotate about the second weakened section.

8. The circuit protection device of claim 6, wherein the force from the squib causes the opening in the busbar to be created at the first weakened section.

9. The circuit protection device of claim 6, wherein the busbar further comprises a brace operable to engage an interior wall of the housing.

10. A pyrotechnic fuse, comprising:
a housing;
a busbar extending through the housing, wherein the busbar is positioned between a first chamber defined by a first section of the housing and a second chamber defined by a second section of the housing; and
a piston within the first chamber, wherein the piston is operable to receive a force from a squib coupled to the first section of the housing, and wherein in response to a signal from a current sensor, the force from the squib causes the piston to create an opening in the busbar.

11. The pyrotechnic fuse of claim 10, further comprising an arc suppressant filler within the first chamber, wherein creation of the opening in the busbar causes the arc suppressant filler to move into the second chamber.

12. The pyrotechnic fuse of claim 10, further comprising a second piston within the first chamber, wherein the second piston comprises a head proximate the squib and a shaft extending through the piston, wherein the shaft is in abutment with the busbar.

13. The pyrotechnic fuse of claim 10, wherein the busbar comprises:
a first end opposite a second end;
a first weakened section adjacent an engagement feature, wherein the first weakened section and the engagement feature are positioned at the first end, and wherein the piston comprises a shaft in abutment with the engagement feature.

14. The pyrotechnic fuse of claim 13, wherein the busbar further comprises a second weakened section at the second end, wherein the force from the squib causes the busbar to deflect about the second weakened section.

15. The pyrotechnic fuse of claim 13, wherein the force from the squib causes the opening in the busbar to be created at the first weakened section.

16. The pyrotechnic fuse of claim 13, wherein the busbar further comprises a brace at the first end, wherein the brace is engaged with an interior wall of the second section of the housing.

17. A method, comprising:
connecting a pyrotechnic fuse to a current sensor, the pyrotechnic fuse comprising a busbar extending through a housing, wherein the busbar is positioned between a first chamber and a second chamber;
receiving a signal from the current sensor that an overcurrent event has occurred; and
in response to the signal from the current sensor, generating a force from a squib coupled to the housing, wherein the force biases a piston towards the busbar to create a break in the busbar.

18. The method of claim 17, further comprising moving an arc suppressant filler from the first chamber to the second chamber through the break of the busbar.

19. The method of claim 17, further comprising engaging a shaft of the piston an engagement feature of the busbar, wherein a first weakened section is located adjacent the engagement feature, and wherein the break in the busbar is created in the first weakened section.

20. The method of claim 19, further comprising rotating the busbar about a second weakened section of the busbar in response to the force on the busbar from the piston.
